(19) United States
(12) Patent Application Publication
(10) Pub. No.: US 2008/0253290 A1
(43) Pub. Date: Oct. 16, 2008

(54) Optimization of Traffic Distribution in Multipath Routing

(75) Inventors: Gero Schollmeier, Gauting (DE); Christian Winkler, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, MUENCHEN (DE)

(21) Appl. No.: 10/586,796

(22) PCT Filed: Jan. 11, 2005
(86) PCT No.: PCT/EP05/50087

§ 371 Date: Jul. 20, 2006

(30) Foreign Application Priority Data
Jan. 23, 2004 (DE) 10-2004-003-5482

(51) Int. Cl. H04L 12/24

(52) U.S. Cl. 370/237

(57) ABSTRACT

A method for optimization of traffic distribution in a communication network with multipath routing is provided. Distribution weightings are provided for a node of the communication network which has several alternatives or downward links for the routing to a target. The distribution weightings are modified relative to each other as a measure of the traffic loading on the downward links in order to reduce distributed traffic on highly loaded links and to increase distributed traffic on the less loaded links. An even traffic distribution on the communication network is thus achieved.

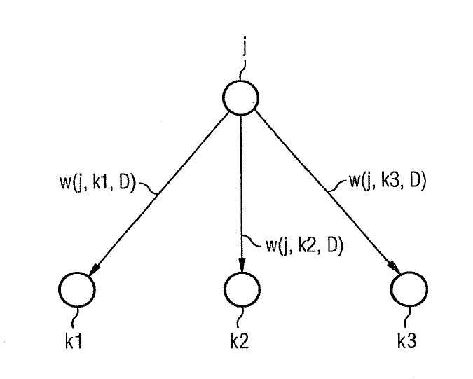

### CROSS REFERENCE TO RELATED APPLICATIONS

This application is the US National Stage of International Application No. PCT/EP2005/050087, filed Jan. 11, 2005 and claims the benefit thereof. The International Application claims the benefits of German application No. 102004003548.2 DE filed Jan. 23, 2004, both of the applications are incorporated by reference herein in their entirety.

### FIELD OF INVENTION

The invention relates to a method for improving traffic distribution in a communication network with multipath routing, said communication network being made up of nodes and links. The subject matter of the invention is of relevance to the field of network technologies, in particular the field of internet technology and switching technology.

### BACKGROUND OF INVENTION

So-called multipath routing plays an increasingly important role in packet-based networks, such as the IP (Internet Protocol) network, in particular. Multipath routing means that traffic to a destination is distributed over a number of routes or paths and forwarded to the destination thus. Multipath routing has the advantage that it is less susceptible to interference and frequently allows better traffic distribution.

Easily the most widely used method for multipath routing in packet-based networks at present is the ECMP (Equal Cost Multi Path) method, based on the OSPF (Single Shortest Path Routing) protocol. In the context of this method a number of paths that are equivalent in the sense of a metric are defined to a destination and the traffic at a node is distributed equally to the output links leading to the destination.

### SUMMARY OF INVENTION

An object of the invention is to specify a method for optimizing traffic distribution in communication networks with multipath routing.

This object is achieved by the independent claims.

The invention is based on the idea of introducing distribution weightings for the distribution of traffic to a number of paths to a destination and adjusting these distribution weightings to achieve optimized traffic distribution. A distribution weighting is thereby a measure of the relative traffic load transported via a link, to which the distribution weighting is assigned. A communication network with multipath routing is thereby assumed, which is made up of nodes and links. Multipath routing thereby means that a node of the communication network has a number of outgoing links, which represent different possibilities for routing to a fixed destination. A destination is for example defined by an address or a set of addresses, with, in the case of a set of addresses, routing within the communication network being identical for said addresses. A destination can for example be defined by an edge node or edge router, to which all traffic or all data packets with specific addresses are routed. The communication network can in principle be a fixed network or a mobile network.

According to the invention the distribution weightings for distribution of the traffic to the links that can be used for routing to the destination are adjusted according to the load or availability of the individual links. The load or availability is described by a parameter and, depending on the value said parameter has for a link, the distribution weighting of said link is increased or reduced in relation to the other distribution weightings. This parameter can for example be the absolute traffic load, the relative traffic load, which is also related to the link bandwidth, any traffic-dependent costs incurred with link usage, link availability, the transit time of traffic on the respective link or the load capacity of the end nodes of the respective link.

The distribution weightings are adjusted such that distribution weightings of links with a higher parameter value are reduced in relation to the distribution weightings of the other links. If the parameter is defined for example by the traffic load on the respective link, the distribution weighting of a link that is more heavily loaded compared with the other links is reduced, i.e. less traffic is distributed to this link. This results in a redistribution of traffic from loaded links to less loaded links. The mean parameter value can be used as the reference point for the adjustment or modification of the distribution weightings. Depending on whether the parameter for a link has a positive or negative difference in respect of the mean value, the associated distribution weighting can be reduced or increased. This increase or reduction of distribution weightings can be carried out in proportion to the gap between the parameter for the respective link and the mean value.

According to a development the distribution weightings are adjusted iteratively, with the distribution weightings being adjusted in each step. This iterative procedure can take place as follows:
The distribution weightings are initialized with start values
A fixed number of iterations is carried out
The distribution weightings resulting after the number of iterations are used for routing to the destination in the communication network

It can be expedient to use an attenuation variable that is a function of the number of the iteration when modifying the distribution weightings in the iterative method, resulting in a reduction in the modification of distribution weightings that increases with the number of iterations. This attenuation variable prevents situations such as the oscillation of a distribution weighting between two values.

In one development of this iterative method the load on subsequent nodes is taken into account by the redistributed traffic. If during the first iteration the parameter is defined by the absolute traffic load or the relative traffic load related to the bandwidth, this can be achieved by modifying the value of the parameter for the next iteration after each iteration. The value of the parameter is then modified such that the impact of the redistribution of the traffic to subsequent nodes or links is taken into account. This modification can for example be achieved by adding a value to the parameter, which is defined by the traffic transported via the link in question to the destination, multiplied by a factor. This measure means that the traffic already transported via the respective link to the destination is taken into account. It counteracts an excessive increase in this element. If the level of all the traffic routed via a link is relatively low for example but the traffic routed to the destination makes up a large part of this, because a variable is added in proportion to the traffic routed via this link to the destination, the parameter modification means that the parameters for this value converge more quickly towards the mean value and less traffic is therefore redistributed to this link (the mean value must then be recalculated after every parameter modification). The fact that less traffic is redistributed to this link is expedient in respect of nodes or links after said link, the overall traffic load of which is not necessarily as low as that of the link in question.

The method can be implemented for all nodes of the communication network, at which traffic distribution is carried out, such that traffic distribution is improved in the communication network as a whole. It is also expedient to implement the method not only for the routes to a destination but for all the different destinations within the network for routing. “Different destinations within the network” means that these destinations do not necessarily correspond precisely to the destination information used for routing the traffic. For example there are very many addresses on the internet, of which a number result in a routing within the communication network that is identical, i.e. has the same input and output nodes, in a communication network that is a sub-network of the internet. Routing for this number of addresses is expediently interpreted as a single destination in the context of the method.

If the parameter is a measure of traffic loading, then the corresponding traffic loading should be known at the start of the method. The traffic volume within the network can for example be measured or calculated using the so-called traffic matrix, which shows how much traffic is to be carried between a source node and a destination node. The traffic volume within the network and therefore the traffic loading on the link can be redetermined in different phases during the method and used for further implementation of the method.
In the case of the iterative procedure, the traffic volume can be redetermined after each iteration to modify the distribution weightings.
The traffic volume can be redetermined after determining the link costs for a node, before determining the link costs for the next node correspondingly.
The traffic volume can be redetermined, once the claimed adjustment of the links costs has been completed for all routes to a destination.
It is expedient to redetermine the traffic volume and to calculate the final traffic distribution in the network after completing the method and determining all link costs.

The points at which and whether the traffic distribution should be recalculated during the method and used for the method are a function of the communication network, the topology of the communication network and the available computing power. The method can be implemented as software on routers, for example internet routers, which support Equal Cost Multi Path (ECMP).

### BRIEF DESCRIPTION OF THE DRAWING

The invention is described in more detail below in the context of an exemplary embodiment with reference to a FIGURE. The sole FIGURE illustrates an exemplary embodiment of an IP network having a plurality of nodes and links in accordance to the present invention.

### DETAILED DESCRIPTION OF INVENTION

An IP network and ECMP multipath routing are assumed for the exemplary embodiment. At the start the ECMP protocol or OSPF protocol is used to calculate least-cost paths for routing within the network based on a metric. As with the ECMP method, for nodes that have two or more least-cost paths for routing that are equivalent in the sense of the metric, all or at least some of these least-cost paths are used for routing. With a number of alternative least-cost paths it is possible to limit the number of paths used, to ensure more regular conditions within the network. After calculating the paths, distribution weightings can be introduced and assigned initial values. The initial distribution weightings are set such that there is equal distribution to all possible paths. Expediently in the context of the method the distribution weightings are standardized to 1, such that the initial values for the distribution weightings at a node that has n path alternatives for a destination are equal to 1/n.

In the context of the exemplary embodiment three loops are passed through. The outermost loop passes through all possible destinations for routing within the network. The second loop, which is a function of the destination, passes through all the nodes that are involved in routing to the respective destination. The third loop corresponds to an iterative modification of the distribution weightings for a specific node and a specific destination. The number of these iterations is for example 10 to 100. The traffic volume on the individual links within the network is used as the input for these iterations. This can be calculated by way of an example or by means of the traffic matrix based on known volumes of traffic going in and out at the network boundaries. The iterative adjustment of the distribution weightings is shown in more detail in the FIGURE. The FIGURE shows a node J and links, on which traffic to other nodes K1, K2 and K3 can be distributed to a specific destination. The distribution is effected according to the distribution weightings (W(J,K1,D) . . . W(J,K3,D). These distribution weightings are also a function of the respective destination D (outermost loop). These distribution weightings are adjusted as a function of the overall traffic transported via the respective link. This traffic is referred to as TRAF(K1) . . . TRAF(K3) (not shown in the FIGURE). The mean value of the traffic transported via the links to the nodes K1 to K3 is referred to as TRAF_AV. The new distribution weightings for K ∈ {K1, K2, K3} are then calculated as follows for each iteration:

W(J,K,D)_{NEW}=W(J,K,D)_{OLD}−(TRAF(K)−TRAF_{—}AV)/TRAF_{—}AV×DELTA

DELTA is thereby an expediently selected adjustment variable or attenuation variable, which is equal to 1: n_IT, where n_IT is equal to the number of the iteration. DELTA has the effect that modification of the distribution weightings is attenuated for the higher iterations, thereby preventing oscillations. With the above formula, the index K passes through the values K1 to K3, i.e. the distribution weightings for the links leading away from the node J to the destination are adjusted. If a value of W(J,K,D)_{NEW}<0 results during the iteration, W(J,K,D)=0 is set. If W(J,K,D)_{NEW}>1 results, W(J,K,D)=1. W(J,K,D) are then standardized such that their sum is 1. The above formula produces a traffic redistribution between the links to the nodes K1 to K3, which relieves the load on links with a high traffic volume and increases the load on links with a low traffic volume. Different link bandwidths can also be taken into account in the context of the exemplary embodiment. The relative traffic load on the links, in other words the traffic valve related to the link bandwidth, is then used instead of the absolute traffic. This makes it possible to take into account different link bandwidths in a simple manner. In the above formula the relative values TRAF(K)/B(K) related to the bandwidth B(K) are then used instead of TRAF(K) and TRAF_AF results as the sum over these relative values.

According to a development the loading on subsequent nodes can also be taken into account as follows. To this end new values for TRAF(K) are calculated for every iteration, in that

TRAF(K)_{NEW}=TRAF(K)_{OLD}+ALPHA×T(K), K ∈ {K1, K2, K3}

is set. Alpha is thereby a factor between 0.5 and 2 and T(K) is the traffic of the node K already present to the destination. The values TRAF(K)_{new} are then used instead of the old values for the next iteration. The mean of the values TRAF(K)_{new} must then be similarly calculated for the next iteration. This development allows the loading of the subsequent nodes K1 to K3 to be taken into account by the redistribution, to prevent the local optimum of traffic distribution in the node J putting pressure on one of the nodes K1 to K3 due to the traffic redistribution. In other words the traffic of the individual nodes in the direction of the destination is taken into account. The modification in the context of this development means that nodes with a low overall traffic load are not loaded with too much new traffic in the direction of the destination, which must then be further distributed by the subsequent nodes. This modification also counteracts traffic to a destination being concentrated on one link that has a lower, optionally a significantly lower, level of traffic load than the other links.

1.-16. (canceled)

17. A method for improving traffic distribution in a communication network with multipath routing, comprising:
providing a plurality of nodes and links in the communication network, wherein one node of the communication network having a plurality of outgoing links, which correspond to alternative paths for routing to a destination and to which traffic to the destination can be distributed;
assigning to the outgoing links distribution weightings for distribution of the traffic to the destination; and
adjusting the distribution weightings according to a parameter related to the load or availability of the individual links, with, in the case of two links with different parameter values, the distribution weighting of the link with the higher parameter value being reduced in relation to the distribution weighting of the other link.

18. The method according to claim 17, wherein the distribution weightings are adjusted according to a gap between the parameter for the respective link and a mean value for the parameter taken over the plurality of outgoing links.

19. The method according to claim 18, wherein each of the plurality of links, the parameter value of which is different from the mean value, the distribution weightings are adjusted, with the distribution weightings of links, the parameter value of which is above the mean value, being reduced and the distribution weightings of links, the parameter value of which is above the mean value being increased.

20. The method according to claim 19, wherein the distribution weightings are increased or reduced in proportion to the gap between the parameter value for the respective link and the mean value.

21. The method according to claim 17, further comprising iteratively adjusting the distribution weightings, with an adjustment of the distribution weightings being carried out with each step.

22. The method according to claim 21, further comprising:
initializing the distribution weightings with start values;
repeating the iteration; and
using the distribution weightings resulting after the repeated iterations for routing in the communication network to the destination.

23. The method according to claim 21, wherein when the distribution weightings are modified, an attenuation variable that is a function of a number of the iteration is used, bringing about a reduction in the modification of distribution weightings that increases with the number of iterations.

24. The method according to claim 21, further comprising:
defining the parameter during the first iteration by an absolute traffic load or a relative traffic load related to a link bandwidth; and
modifying the value of the parameter during the iterations for the next iteration, with the modification taking into account the traffic transported via the link to the destination.

25. The method according to claim 24, further comprising adding the traffic transported via the link to the destination multiplied by a factor.

26. The method according to claim 17, wherein the traffic distribution in the communication network is recalculated using the resulting distribution weightings.

27. The method according to claim 17,
wherein the method is implemented for a plurality of nodes in communication network, at which traffic distribution takes place, and
wherein the method is implemented for a plurality of destinations.

28. The method according to claim 17, wherein the parameter is defined by an absolute traffic load, a relative traffic load related to the link bandwidth, a traffic-related costs incurred during link usage, a link availability, a transit time of the respective link or a load capacity of the end nodes of the respective link.

29. The method according to claim 17,
wherein the distribution weightings of a node to a destination are standardized and this standardization is maintained during modification, and
wherein the distribution weightings for multipath routing are adjusted in the context of a ECMP (Equal Cost Multi Path) method.

30. The method according to claim 17, wherein the method is implemented in a router.

31. A method for traffic distribution in a communication network having multipath routing, comprising:
providing a first network node operatively connected to a plurality of subsequent network nodes, each connection having a link that is an outgoing link with respect to the network node, whereby a plurality of outgoing links are provided, the connections providing paths for distributing the traffic to a destination; and
for each outgoing link:
assigning a distribution weighting for the traffic distribution to the respective link, and
adjusting the distribution weighting according to a value related to the availability of the respective link, the weighting adjusted such that when the value of the respective link is greater than the value of a different outgoing link the weighting of the respective link is reduced in relation to the weighting of the different outgoing link.

32. The method according to claim 31, wherein the value is based on the availability or load for the corresponding link.

33. The method according to claim 31, wherein the distribution weighting is adjusted according to a gap between the value for the respective link and an average of the values for the plurality of links.

34. The method according to claim 33,
wherein the distribution weighting is adjusted for each link having a value that is different from the average,
wherein the distribution weighting is reduced when the value is greater than the average, and
wherein the distribution weighting is increased when the value is less than the average and

35. The method according to claim 34, wherein the distribution weighting is increased or reduced in proportion to the gap between the value for the respective link and the average.

36. The method according to claim 31, further comprising repeating the adjustment step.

37. The method according to claim 36, further comprising:
initializing the distribution weightings with a start value,
repeating the adjustment step a plurality of times, and
using each distribution weighting resulting after the plurality of repetitions for routing to the destination.

38. The method according to claim 36, further providing an attenuation variable that is a function of the number of the iteration, wherein the attenuation variable is used in adjusting the distribution weighting, the attenuation variable providing reduction in the adjustment of each distribution weighting that increases with the number of iterations.

39. The method according to claim 36,
wherein the value is defined during the first iteration by the absolute traffic load or the relative traffic load related to a bandwidth or the relative link, and
wherein the value is modified during the iterations for the next iteration, with the modification taking into account the traffic transported via the link to the destination.

40. The method according to claim 39, further comprising the modification is effected by adding the traffic transported via the link to the destination multiplied by a factor.
